(19) United States
(12) Patent Application Publication
(10) Pub. No.: US 2022/0260666 A1
(43) Pub. Date: Aug. 18, 2022

(54) POSITION DETERMINATION USING A SIDELINK

(71) Applicant: Telefonaktiebolaget LM Ericsson (publ), Stockholm (SE)

(72) Inventors: Tommy ARNGREN, Södra Sunderbyn (SE); Stefan WÄNSTEDT, Luleå (SE); Tomas JÖNSSON, Luleå (SE); Peter ÖKVIST, Luleå (SE)

(21) Appl. No.: 17/610,317

(22) PCT Filed: May 13, 2019
(86) PCT No.: PCT/SE2019/050426

§ 371 Date: Nov. 10, 2021

(51) Int. Cl. G01S 5/00; H04W 52/36; H04W 76/14

(52) U.S. Cl. CPC G01S 5/0072; G01S 5/0063; H04W 92/18; H04W 76/14; H04W 52/367

(57) ABSTRACT

There are provided mechanisms for position determination using a sidelink. A method is performed by a first terminal device. The method includes receiving, via the sidelink to a second terminal device, positioning information of the second terminal device. The method includes determining its own position from the positioning information.

### TECHNICAL FIELD

Embodiments presented herein relate to a method, a first terminal device, a computer program, and a computer program product for position determination using a sidelink. Further embodiments presented herein relate to a method, a second terminal device, a computer program, and a computer program product for enabling position determination using the sidelink. Further embodiments presented herein relate to a method, a network node, a computer program, and a computer program product for enabling position determination using the sidelink.

### BACKGROUND

One challenge in communications networks is to accurately determine the position of terminal devices served by the communications networks. A summary of some existing positioning technologies that can be used in a communications network for determining the position of a terminal device served by the communications network will be provided next.

OTDOA (Observed Time Difference Of Arrival) is a positioning feature introduced in Release 9 of the Long Term Evolution (LTE) telecommunications standard. According to OTDOA, each terminal device estimates the time difference of arrival (TDOA) based on received measurements from network nodes with known location. TDOA is calculated as the difference in time of arrival (TOA) between a reference node and other nodes. OTDOA requires network time synchronization, but no device-to-network synchronization is required since the time difference is independent of the device-to-network time offset. According to LTE, positioning reference signal (PRS) are used to estimate TDOA from correlation peaks in the power delay profile, and the PRS is designed for good detectability of multiple cells. The network node does not schedule data in the sub-frames sending PRS in order to create low-interference sub-frames, and PRSs can be muted on some transmission occasions to increase detectability of distant cells. There is a good chance to achieve an accuracy of a few meters (in general) with OTDOA given that network time synchronization is in the order of 100 ns and that the PRSs are configured per cell providing good correlation properties.

It is currently not possible to distinguish Radio Dots (RDs) connected to the same indoor radio unit (IRU) from each other. This implies that positioning information via RDs is only possible on a cell-ID resolution level. This further implies that that large cells with up to 8 RDs connected to the same IRU would only give low positioning accuracy. It is however assumed that per-RD positioning might become possible in combination with Uplink-Time DOA, achieving a resolution in the order of 5 m in some deployments and for some radio conditions.

Wi-Fi (i.e., wireless local area networking of devices based on the IEEE 802.11 standards) is commonly present in many venues and a plethora of different positioning mechanisms are available, some achieving a resolution in the order of 5-10 m depending on deployment, hardware characteristics and radio conditions. In combination with Bluetooth low energy (BLE), Received Signal Strength Indicator (RSSI), and/or angle of arrival (AOA) measurements, a resolution of less than 3 m or better can be achieved.

The inherent high time resolution in ultra wideband radio (UWB) signals enables precise positioning, and large bandwidth (wider than 500 MHz) provides frequency diversity making the time-modulated (TM) UWB signal resistant to multipath and interference. UWB positioning products claims a resolution in the order of 10 cm.

In some scenarios, especially in the absence of cellular networks, the resolution of the above disclosed positioning mechanisms is not high enough. With UWB accurate positioning is achievable. However, using UWB requires additional and dedicated hardware deployment.

Hence, there is still a need for improved position determination of terminal devices served by a communications network.

### SUMMARY

An object of embodiments herein is to provide efficient position determination of a terminal device served by a communications network.

According to a first aspect there is presented a method for position determination using a sidelink. The method is performed by a first terminal device. The method comprises receiving, via the sidelink to a second terminal device, positioning information of the second terminal device. The method comprises determining its own position from the positioning information.

According to a second aspect there is presented a first terminal device for position determination using a sidelink. The first terminal device comprises processing circuitry. The processing circuitry is configured to cause the first terminal device to receive, via the sidelink to a second terminal device, positioning information of the second terminal device. The processing circuitry is configured to cause the first terminal device to determine its own position from the positioning information.

According to a third aspect there is presented a computer program for position determination using a sidelink, the computer program comprising computer program code which, when run on processing circuitry of a first terminal device, causes the first terminal device to perform a method according to the first aspect.

According to a fourth aspect there is presented a method for enabling position determination using a sidelink. The method is performed by a second terminal device. The method comprises obtaining an indication to provide its own positioning information to a first terminal device. The method comprises transmitting, via the sidelink to the first terminal device, the positioning information.

According to a fifth aspect there is presented a second terminal device for enabling position determination using a sidelink. The second terminal device comprises processing circuitry. The processing circuitry is configured to cause the second terminal device to obtain an indication to provide its own positioning information to a first terminal device. The processing circuitry is configured to cause the second terminal device to transmit, via the sidelink to the first terminal device, the positioning information.

According to a sixth aspect there is presented a computer program for enabling position determination using a sidelink, the computer program comprising computer program code which, when run on processing circuitry of a second terminal device, causes the second terminal device to perform a method according to the fourth aspect.

According to a seventh aspect there is presented a method for enabling position determination using a sidelink. The method is performed by a network node. The method comprises receiving a request from one of a first terminal device served by the network node and a second terminal device served by the network node for establishment of the sidelink between the first terminal device and the second terminal device for provision of positioning information from the second terminal device to the first terminal device. The method comprises requesting the other of the first terminal device and the second terminal device to establish the sidelink for the provision of the positioning information from the second terminal device to the first terminal device.

According to an eight aspect there is presented a network node for enabling position determination using a sidelink. The network node comprises processing circuitry. The processing circuitry is configured to cause the network node to receive a request from one of a first terminal device served by the network node and a second terminal device served by the network node for establishment of the sidelink between the first terminal device and the second terminal device for provision of positioning information from the second terminal device to the first terminal device. The processing circuitry is configured to cause the network node to request the other of the first terminal device and the second terminal device to establish the sidelink for the provision of the positioning information from the second terminal device to the first terminal device.

According to a tenth aspect there is presented a computer program for enabling position determination using a sidelink, the computer program comprising computer program code which, when run on processing circuitry of a network node, causes the network node to perform a method according to the seventh aspect.

According to an eleventh aspect there is presented a computer program product comprising a computer program according to at least one of the third aspect, the sixth aspect, and the tenth aspect and a computer readable storage medium on which the computer program is stored. The computer readable storage medium can be a non-transitory computer readable storage medium.

Advantageously these methods, these first terminal devices, these second terminal devices, these network nodes, these computer programs, and this computer program product provide efficient position determination of the first terminal device.

Advantageously these methods, these first terminal devices, these second terminal devices, these network nodes, these computer programs, and this computer program product provide means for accurate indoor positioning by reusing known positioning information from the second terminal device, and where the positioning information is efficiently conveyed directly between the terminal devices using a cellular D2D mechanism.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 2 and 6 are schematic diagrams illustrating a communications network according to embodiments;

FIGS. 3, 4, and 5 are flowcharts of methods according to embodiments;

FIGS. 7 and 8 are signalling diagrams of methods according to embodiments;

FIG. 9 is a schematic diagram showing functional units of a first terminal device according to an embodiment;

FIG. 10 is a schematic diagram showing functional modules of a first terminal device according to an embodiment;

FIG. 11 is a schematic diagram showing functional units of a second terminal device according to an embodiment;

FIG. 12 is a schematic diagram showing functional modules of a second terminal device according to an embodiment;

FIG. 13 is a schematic diagram showing functional units of a network node according to an embodiment;

FIG. 14 is a schematic diagram showing functional modules of a network node according to an embodiment; and

FIG. 15 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As disclosed above, there is a need for improved position determination of terminal devices served by a communications network.

According to at least some of the herein disclosed embodiments accurate position determination of a terminal device is enabled using a device-to-device sidelink communications between a stationary terminal device having accurate positioning information and the terminal device for which the position is to be determined.

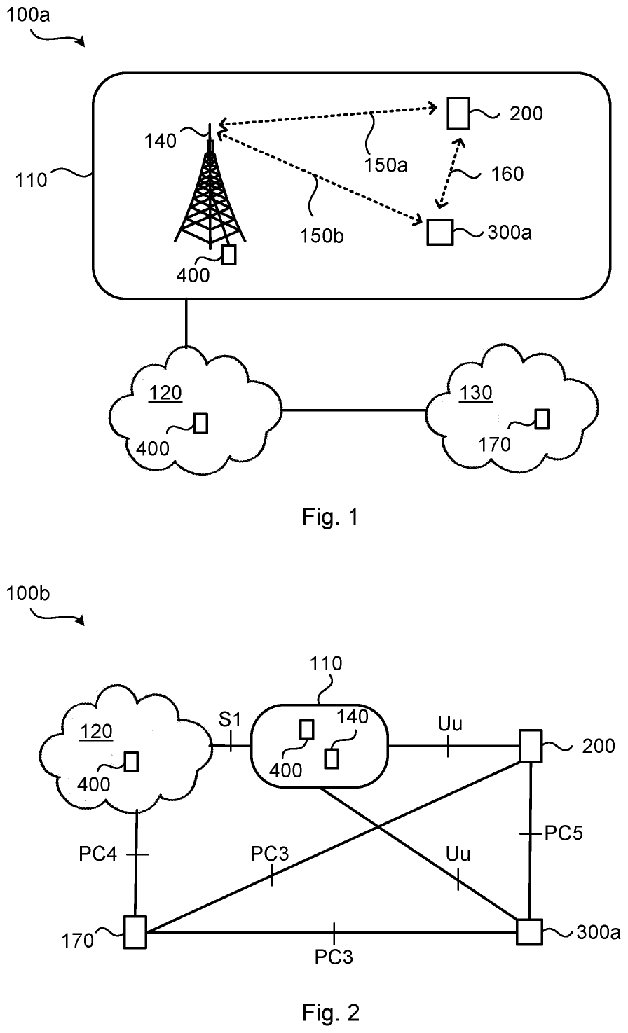

FIG. 1 is a schematic diagram illustrating a communications network 100a where embodiments presented herein can be applied. The communications networks 100a, could be a third generation (3G) telecommunications network, a fourth generation (4G) telecommunications network, or a fifth (5G) telecommunications network, or any combination thereof, and support any 3GPP telecommunications standard, where applicable.

The communications network 100a comprises a radio access network 110, a core network 120, and a service network 130, which are interconnected with each other. In turn, the radio access network 110 comprises a radio access network node 140 configured to provides network access to terminal devices 200, 300a within the cell served by the radio access network node 140, thus enabling the terminal device 200, 2300a00 to communicate with over a wireless link 150a, 150b. The terminal devices 200, 300a are thereby enabled to, via the radio access network node 140, access services of, and exchange data with, the service network 130.

Operation of the radio access network node 140 is controlled by a network node 400. The network node 400 could be part of, integrated with, collocated with, or physically separated from, the radio access network node 140. The terminal devices 200, 300a are further configured to communicate directly with each other over a wireless sidelink 160. As will be further disclosed below, the wireless sidelink 160 is facilitated by a proximity-based services (ProSe) as provided by a ProSe server 170. In some examples the terminal device 200, 300a adapts their power for uplink data and control transmission (PPSCCH and PPSSCH) towards the network node 400 according to the following when transmission over the sidelink 160 is enabled:

P_{PSCCH}=min{P_{CMAX,PSCCH},P_{O,SC}+α_{SC}·PL}

P_{PSSCH}=min{P_{CMAX,PSSCH},10 log₁₀(M_{PSSCH})+P_{O,data}+α_{data}·L}

where P_{CMAX,PSCCH} and P_{CMAX,PSSCH} are the maximum allowed power levels for PSCCH and PSSCH transmission, where M_{PSSCH} is the bandwidth of the PSSCH resource assignment expressed in number of resource blocks, where PL corresponds to the downlink path loss estimate calculated in the terminal device for the serving cell c, where α_{SC} and α_{data} represent the so called fractional path loss compensation for PSCCH and PSSCH transmission, where PL is the path loss, where P_{O,SC} is the target received power for control signalling, and where P_{O,data} is the target received power for data signalling.

Examples of radio access network nodes 140 are radio base stations, base transceiver stations, Node Bs (NBs), evolved Node Bs (eNBs), gNBs, access points, and access nodes, and backhaul nodes. Examples of terminal devices 200, 300a are wireless devices, mobile stations, mobile phones, handsets, wireless local loop phones, user equipment (UE), smartphones, laptop computers, tablet computers, network equipped sensors, network equipped vehicles, machine type communication (MTC) devices, and so-called Internet of Things (IoT) devices. As the skilled person the communications network 100a might comprise a plurality of radio access network nodes 140 providing network access to a plurality of terminal devices 200, 300a. In some examples the second terminal device 300a is configured to have a fixed location. That is, in some examples the second terminal device 300a has a stationary geographical location in the communications network 100a. For example, the second terminal device 300a might be mountable to a fixed structure, such as a building, a tunnel, a bridge, a railway, or a natural occurring structure, such as a rock, etc.

FIG. 2 is a schematic diagram illustrating a communications network 100b showing the communications interfaces between the entities of the communications network 100a of FIG. 1. The first terminal device 200 and the second terminal device 300a communicate with each other over communication interface PC5, the first terminal device 200 and the second terminal device 300a communicate with the radio access network (including the radio access network node 140 and possibly the network node 400) over communication interface Uu, and the first terminal device 200 and the second terminal device 300a communicate with the ProSe server 170 over communication interface PC3. That is, the sidelink 160 is established over the PC5 interface, and the wireless links 150a, 150b are established over the Uu interface. For 3GPP Release 12 and onwards, the PC5 interface is a one-to-many communication interface, i.e. it is specified for group communication. From a higher protocol layer perspective (e.g., from protocol layer 2 (the data link layer) and upwards), this is reflected in the assignment of destination identities (IDs), which according to the ProSe functionality are always group IDs. The Internet Protocol (IP) address of the ProSe server 170 might be preconfigured (hard-coded) in the terminal device 200, 300a. Alternatively, the terminal device 200, 300a identify the IP address of the ProSe server 170 via a domain name server (DNS) look-up. To contact the ProSe server 170 the terminal device 200, 300a have to establish a radio resource control (RRC) connection with the network node over the Uu interface. The radio access network (including the radio access network node 140 and possibly the network node 400) communicates with the core network 120 (possibly including the network node 400) over communication interface S1, and the core network 120 (possibly including the network node 400) communicates with the ProSe server 170 over communication interface PC4. As the skilled person understands, these are just examples of communication interfaces and the entities of FIGS. 1 and 2 might be configured to communicate with each other using other communication interfaces, depending on the actual implementation of the communications network 100a, 100b, for example with regards to which telecommunications standard is to be supported (e.g., Long Term Evolution (LTE), New Radio (NR), etc.).

The embodiments disclosed herein relate to mechanisms for position determination of the first terminal device 200 using the sidelink 160, and to mechanisms for enabling such position determination of the first terminal device 200. In order to obtain such mechanisms there is provided a first terminal device 200, a method performed by the first terminal device 200, a computer program product comprising code, for example in the form of a computer program, that when run on processing circuitry of the first terminal device 200, causes the first terminal device 200 to perform the method. In order to obtain such mechanisms there is further provided a second terminal device 300a, a method performed by the second terminal device 300a, and a computer program product comprising code, for example in the form of a computer program, that when run on processing circuitry of the second terminal device 300a, causes the second terminal device 300a to perform the method. In order to obtain such mechanisms there is further provided a network node 400, a method performed by the network node 400, and a computer program product comprising code, for example in the form of a computer program, that when run on processing circuitry of the network node 400, causes the network node 400 to perform the method.

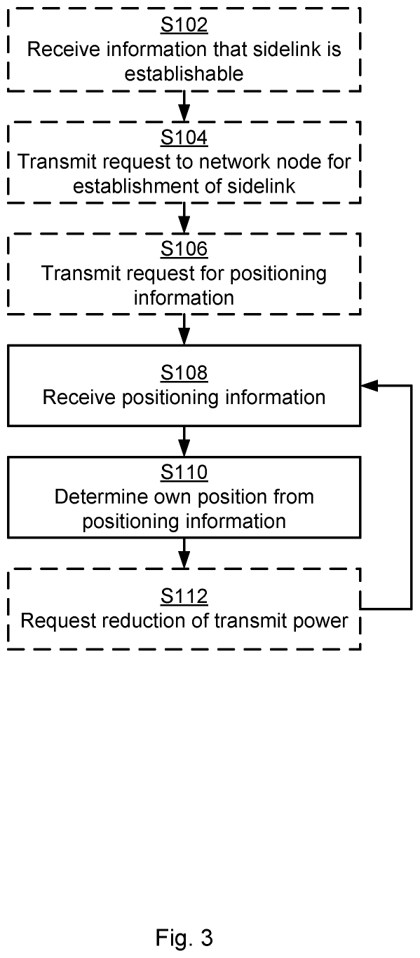

Reference is now made to FIG. 3 illustrating a method for position determination using a sidelink 160 as performed by the first terminal device 200 according to an embodiment.

S108: The first terminal device 200 receives, via the sidelink 160 to the second terminal device 300a, positioning information of the second terminal device 300a.

S110: The first terminal device 200 determines its own position from the positioning information.

Embodiments relating to further details of position determination using a sidelink 160 as performed by the first terminal device 200 will now be disclosed.

In some examples the sidelink 160 is established over interface PC5.

In some aspects the sidelink 160 needs to be established for the first terminal device 200 to receive the positioning information. The sidelink 160 then needs to be established before the positioning information in S108 is received. According to an embodiment the first terminal device 200 is therefore configured to perform (optional) step S102:

S102: The first terminal device 200 receives information from the network node 400 serving the first terminal device 200 that the sidelink 160 is establishable to the second terminal device 300a.

The sidelink 160 might be established either by request from the first terminal device 200 or by request from the second terminal device 300a. According to an embodiment the first terminal device 200 is therefore configured to perform (optional) step S104:

S104: The first terminal device 200 transmits a request to the network node 400 for establishment of the sidelink 160.

In some aspects the transmission of the positioning information is initiated by the second terminal device 300a and in other aspects the transmission of the positioning information is initiated by the first terminal device 200. According to an embodiment the first terminal device 200 is therefore configured to perform (optional) step S106:

S106: The first terminal device 200 transmits, via the sidelink 160, a request to the second terminal device 300a for the positioning information.

There might be different conditions for the first terminal 200 to transmit the request in S106. One such condition might be that the first terminal device 200 is without access to own positioning information. That is, according to an embodiment, the first terminal device 200 is without access to its own positioning information when transmitting the request. One example of this is when the first terminal device 200 has lost an operative connection to a global positioning service.

There may be different ways for the first terminal device 200 to determine its own position from the positioning information received in S108.

In some aspects the own position is equal to the position given by the positioning information. That is, according to an embodiment, the own position is determined to be equal to a position of the second terminal device 300a as given by the positioning information of the second terminal device 300a.

In some aspects the first terminal device 200 makes use of known signal power levels, to further improve positioning accuracy, when receiving the positioning information in S108. In particular, according to an embodiment, the positioning information is in S108 received in a message for which a received power level is measured, and the own position is determined as a function of the positioning information and the measured received power level. The message might comprise details of with which transmit power level the message was transmitted from the second terminal device 300a. The own position might then be determined also as a function of the transmit power level.

In some aspects the first terminal device 200 receives positioning information from at least two, or even a plurality of, second terminal devices 300a, 300b, 300c and corresponding values of the transmission power used for transmitting the positioning information. That is, according to an embodiment, pieces of positioning information of at least two second terminal devices 300a, 300b, 300c are received, and the own position is determined from a combination of all the received pieces of positioning information. In some aspects the first terminal device 200 then uses the information of the transmission power to improve the accuracy of the position determination.

For example, in a scenario where the first terminal device 200 receives positioning information from four second terminal devices without any information of the values of the transmission power, the first terminal device 200 is only enabled to determine its position as a linear average of the respective positions of the four second terminal devices, i.e. basic triangulation. In a scenario where the first terminal device 200 in fact has all these four second terminal devices ahead in the travel direction, the basic triangulation will provide poor accuracy as the first terminal device 200 will determine its position as being in the middle with respect to the four second terminal devices, which it in this case is not. With information of the transmission power as well as the received power, the first terminal device 200 might sort the list of positioning providing second terminal devices to know which one that is likely being the closest one, second closest, etc. Depending on the relative received signal strength and corresponding known positions of the second terminal devices, the first terminal device 200 could further determine its own position more accurately.

In some aspects where positioning information is received from more than one second terminal device, the first terminal device 200 uses only the position information received at highest received power. That is, according to an embodiment, pieces of positioning information of at least two second terminal devices 300a, 300b, 300c are received, and the own position is determined only from the positioning information received with highest received power.

As an illustrative example, assume that the first terminal device 200 has received positioning information and information of the transmission power from two second terminal devices, second terminal device A and second terminal device B, with transmission power values PtxA and PtxB, respectively. At the first terminal device 200, corresponding values of the receive power values PrxA and PrxB. The distance between second terminal device A and second terminal device B can be calculated by the first terminal device 200 based on signaled information and is denoted ΔAB, the unknown distance between the first terminal device 200 and terminal device A is denoted ΔAV. Then, the pathloss between the first terminal device 200 and the second terminal device B can be expressed as:

$${PL}_{B} = PrxB - PtxB = 20 {log}_{10} ( \frac{λ}{4 π \cdot d} )$$

Where λ is the carrier wavelength and d denotes the distance between the first terminal device 200 and the second terminal device B, i.e. ΔAB+ΔAV. Given that PL_{B} can be calculated by the first terminal device 200, and that first terminal device 200 also knows ΔAB, then ΔAR can be solved from the above equation, according to:

$$Δ AV = \frac{λ}{4 π} {10}^{- ( \frac{{PL}_{B}}{20} )} - Δ AB .$$

The first terminal device 200 might validate (or at least test its previous calculation) by using the above achieved distance measure with a direct calculation thereof (“#2”), and compared that to measured data (“#1”), according to:

$${PL}_{A} \#1 = “ measured by VUE as ( PrxA - PtxA ) ” \\ {PL}_{A} \#2 = 20 {log}_{10} ( \frac{λ}{4 π \cdot Δ AV} )$$

If then (PL_{A} #1−PL_{A} #2)<accuracy threshold, then the first terminal device 200 could consider the above calculation sufficiently accurate.

Further, the first terminal device 200 might be configured to apply the same calculation scheme also including yet other second terminal devices, to further improve the accuracy.

The above calculation assumes free space path loss between the transmitting and receiving terminal devices, i.e. that the pathloss exponent equals “2” (i.e. “d-squared” in the expression

$$… 10 {log}_{10} ( \frac{λ}{4 π {d}^{2}} ) ) ;$$

naturally, the suggested calculation scheme could be modified to use other empirical pathloss exponents found in the literature.

In further aspects, as the pathloss-to-distance curve is logarithmic and that the slope will be different depending on operation point (i.e. distance), the first terminal device 200 could request neighboring second terminal devices to adjust their transmit powers for the sake of the first terminal device 200 to carry out above suggested method at different operation points. The first terminal device 200 might thus further request the second terminal devices 300a, 300b, 300c to reduce their transmission power for next transmission of their positioning information. That is, according to an embodiment, pieces of positioning information of at least two second terminal devices 300a, 300b, 300c are received, and the first terminal device 200 is configured to perform (optional) step S112:

S112: The first terminal device 200 requests at least one of the second terminal devices 300a, 300b, 300c to reduce their transmit power when re-transmitting the positioning information.

In further detail, the first terminal device 200 might requests the second terminal devices 300a, 300b, 300c to provide the positioning information using a transmission power that is x dB lower than according to a previous transmission of the positioning information. In some examples the value of x is determined as the difference between SL_RxPwr_2^{nd}_strongest and SL_RxPwr_2^{nd}_weakest, where SL_RxPwr_2^{nd}_strongest is the second strongest received sidelink power (as measured for one second terminal device) and SL_RxPwr_2^{nd}_weakest is the second weakest received sidelink power (as measured for another second terminal device).

The first terminal device 200 might then receive further positioning information as in S108, possibly with further execution of steps S110 and S112 as needed.

As will be further disclosed below, sensor measurements as captured by a sensor at the second terminal device 300a might be communicated to the first terminal device 200 via the sidelink 160. Particularly, according to an embodiment, the positioning information is accompanied by sensor measurements as valid for the position given by the positioning information.

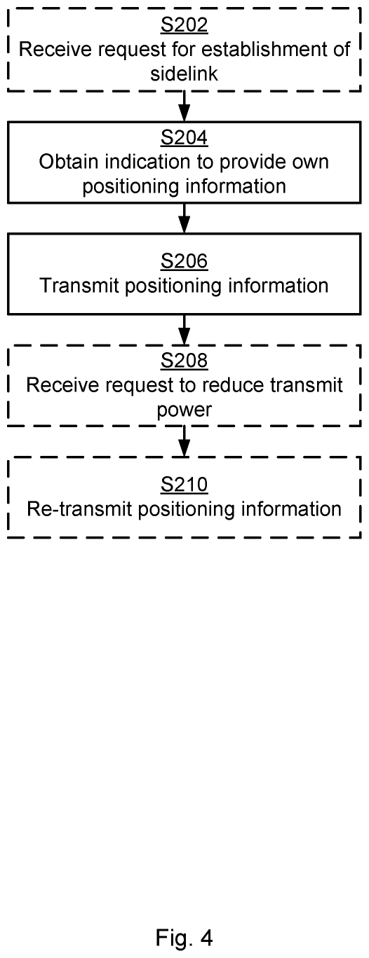

Reference is now made to FIG. 4 illustrating a method for enabling position determination using a sidelink 160 as performed by the second terminal device 300a according to an embodiment.

S204: The second terminal device 300a obtains an indication to provide its own positioning information to a first terminal device 200.

S206: The second terminal device 300a transmits, via the sidelink 160 to the first terminal device 200, the positioning information.

Embodiments relating to further details of enabling position determination using a sidelink 160 as performed by the second terminal device 300a will now be disclosed.

In some examples the sidelink 160 is established over interface PC5.

There may be different ways for the second terminal device 300a to obtain the indication in S204.

In some aspects the indication is obtained by the second terminal device 300a sensing presence (by means of light, vibration, sound, etc.) of the first terminal device 200. That is, according to an embodiment, the second terminal device 300a comprises at least one sensor, and the indication is obtained from input to at least one of the at least one sensor.

In some aspects the indication is obtained by the second terminal device 300a receiving an explicit request from the first terminal device 200. That is, according to an embodiment, the indication is obtained as a request received from the first terminal device 200 for the positioning information.

In some aspects the indication is obtained by the second terminal device 300a receiving a request from the network node 400 to set up the sidelink 160 to the first terminal device 200. That is, according to an embodiment, the second terminal device 300a is configured to perform (optional) step S202:

S202: The second terminal device 300a receives a request from the network node 400 serving the second terminal device 300a for establishment of the sidelink 160.

As disclosed above, the first terminal device 200 might request the second terminal device 300a to reduce its transmission power for transmitting the positioning information to the first terminal device 200. The second terminal device 300a might then provide the first terminal device 200 with positioning information with a certain transmission power reduced by x dB according to the request from first terminal device 200. That is, according to an embodiment, the second terminal device 300a is configured to perform (optional) steps S208, S210:

S208: The second terminal device 300a receives a request to transmit the positioning information with a reduced transmission power.

S210: The second terminal device 300a re-transmits, via the sidelink 160 to the first terminal device 200 and using the reduced transmission power, the positioning information.

The request in S208 might be received from the first terminal device 200 via the sidelink 160 or from the network node 300.

As disclosed above, in some aspects the first terminal device 200 makes use of known signal power levels, to further improve positioning accuracy, when receiving the positioning information in S108. The second terminal device 300a might therefore include an indication of its transmit power level when transmitting the positioning information in S206 (as well as in optional step S210, when performed). That is, according to an embodiment, the positioning information is transmitted in a message, and the message comprises details of with which transmit power level the message was transmitted from the second terminal device 300a.

As disclosed above, the second terminal device 300a might comprise at least one sensor. Depending on the type of sensor, sensor measurements as captured by the sensor might be communicated to the first terminal device 200 via the sidelink 160. Particularly, according to an embodiment, the positioning information is accompanied by sensor measurements as valid for the position given by the positioning information. The sensor measurements might pertain to any of: location temperature, pressure, moisture level, dust level, oxygen level, carbon monoxide level, nitrogen monoxide level, or other gas levels, etc.

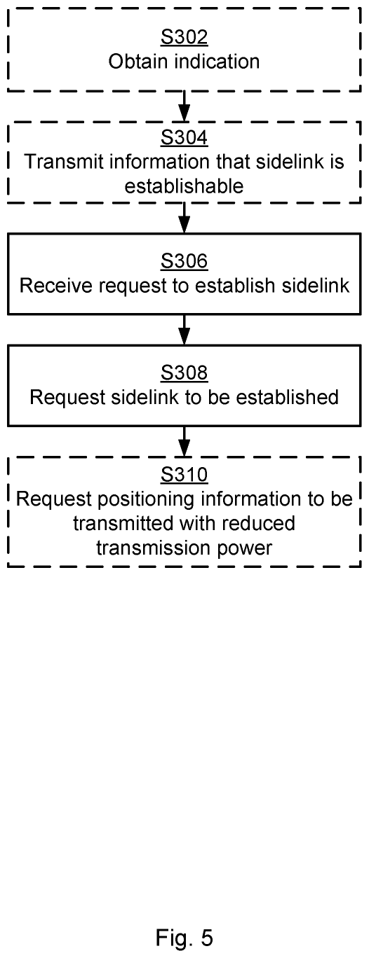

Reference is now made to FIG. 5 illustrating a method for enabling position determination using a sidelink 160 as performed by the network node 400 according to an embodiment.

S306: The network node 400 receives a request from one of the first terminal device 200 served by the network node 400 and the second terminal device 300a served by the network node 400 for establishment of the sidelink 160 between the first terminal device 200 and the second terminal device 300a for provision of positioning information from the second terminal device 300a to the first terminal device 200.

S308: The network node 400 requests the other of the first terminal device 200 and the second terminal device 300a to establish the sidelink 160 for the provision of the positioning information from the second terminal device 300a to the first terminal device 200.

It is thus assumed that both the first terminal device 200 and the second terminal device 300 are requested, or even instructed or ordered, to establish the sidelink 160. The request might further comprise instructions for the first terminal device 200 and the second terminal device 300 to not use uplink resources when transmission over the sidelink 160 is expected to be received.

Embodiments relating to further details of enabling position determination using a sidelink 160 as performed by the network node 400 will now be disclosed.

As disclosed above, in some aspects the sidelink 160 needs to be established for the first terminal device 200 to receive the positioning information and according to an embodiment the first terminal device 200 receives information from the network node 400 serving the first terminal device 200 that the sidelink 160 is establishable to the second terminal device 300a. this could be the case when the network node 400 detects that the first terminal device 200 has entered the coverage area of the sidelink 160 to second terminal device 300a. That is, according to an embodiment, the network node 400 is configured to perform (optional) step S310:

S302: The network node 400 obtains an indication that the first terminal device 200 has entered a coverage area of the sidelink 160 to the second terminal device 300a.

S304: The network node 400 transmits information to the first terminal device 200 that the sidelink 160 is establishable to the second terminal device 300a.

The network node 400 might be configured to request the second terminal device 300a to transmits its positioning information to the first terminal device 200 upon the sidelink 160 having been established.

As disclosed above, the first terminal device 200 might request the second terminal devices 300a, 300b, 300c to reduce their transmission power for next transmission of their positioning information. This reduction of transmission power might be orchestrated by the network node 400. That is, according to an embodiment, the network node 400 is configured to perform (optional) step S310:

S310: The network node 400 requests the second terminal device 300a to transmit the positioning information with a reduced transmission power.

In some examples the requesting is based on a request received from the first terminal device 200.

According to an example, the second terminal device 300a is in S310 requested to reduce its transmission power to a fixed transmission power level.

In some aspects, the network node 400 receiving a request for sidelink communication for positioning information might thus trigger the use of a specific power setting for the sidelink 160. There might be different ways for the network node 300 to orchestrate this reduction of transmission power for the second terminal devices 300a, 300b, 300c.

In some aspects the network node 400 includes a power setting for the second terminal devices 300a, 300b, 300c to be used for the transmission over the sidelink 160, for example to compensate/alter the fact that the first terminal device 200 currently adjusts its reception according to the measured downlink pathloss from the network node 400. Examples of parameters to be altered are in the set of transmission parameters containing entries for α_{SC}, α_{data}, P_{O,SC} and P_{O,data} as in the above expression for P_{PSCCH} and P_{PSSCH}. For example, P_{CMAX,PSSCH} could be set to a low, for example hardcoded, minimum value to be used in short range positioning signaling contexts. For example, setting α_{SC}=α_{data}=0, makes an uplink transmission not depending on the pathloss.

In some aspects the network node 400 might inform the first terminal device 200 that the second terminal device 300a is requested to transmit the positioning information with a specific power level for the sake of accurate positioning. Likewise, information of what transmission power is used could be communicated directly from the second terminal device 300a to the first terminal device 200.

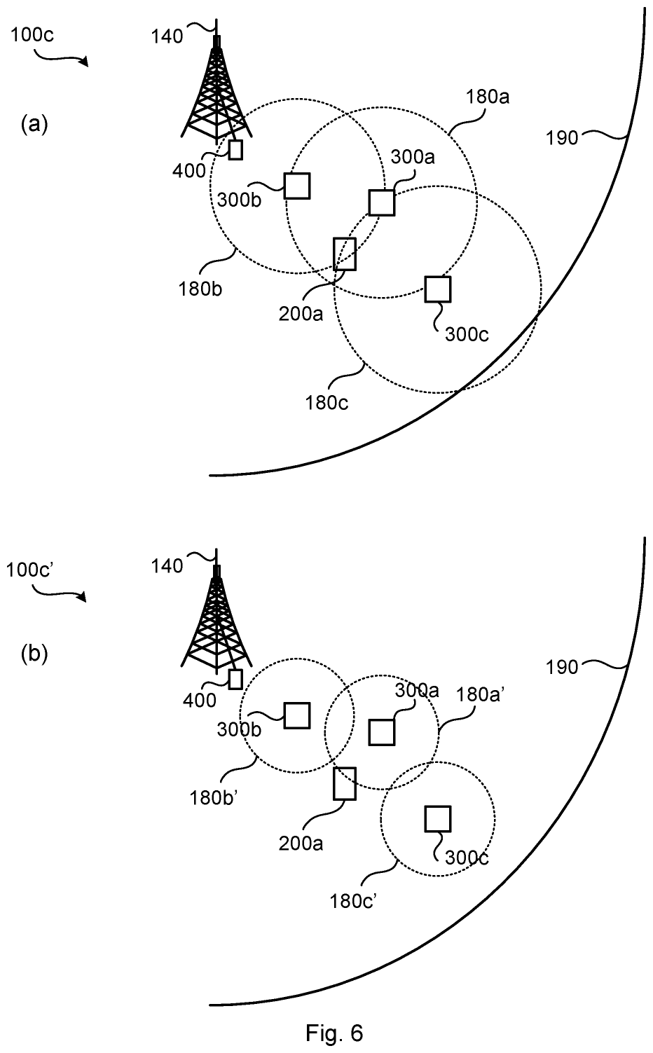

FIGS. 6(a) and (b) illustrates two examples of a communications network 100c, 100c′ before and after power reduction at the second terminal devices 300a, 300b, 300c, respectively. In more detail, FIG. 6(a) schematically illustrates a first example of how the ranges 180a, 180b, 180c of the sidelink transmission for each of the second terminal devices 300a, 300b, 300c changes with respect to their distance to the TRP 140 of the network node 400; the transmission power, and thus the range and power of the sidelink transmission increases with the distance towards the TRP 140 and thus the range and power of the sidelink transmission for second terminal device 300c positioned closest to the cell edge 190 and farthest from the TRP 140 is higher than the range and power of the sidelink transmission for second terminal device 300a positioned closer to the TRP 140, which in turn is higher than the range and power of the sidelink transmission for second terminal device 300b positioned closest to the TRP 140. As a result thereof, first terminal device 200 receives positioning information from all second terminal devices 300a, 300b, 300c. In the example of FIG. 6(b), the transmission power for the sidelink, and thus also the ranges 180a′, 180b′, 180c have been reduced. As a result thereof, first terminal device 200 receives positioning information only from second terminal device 300a.

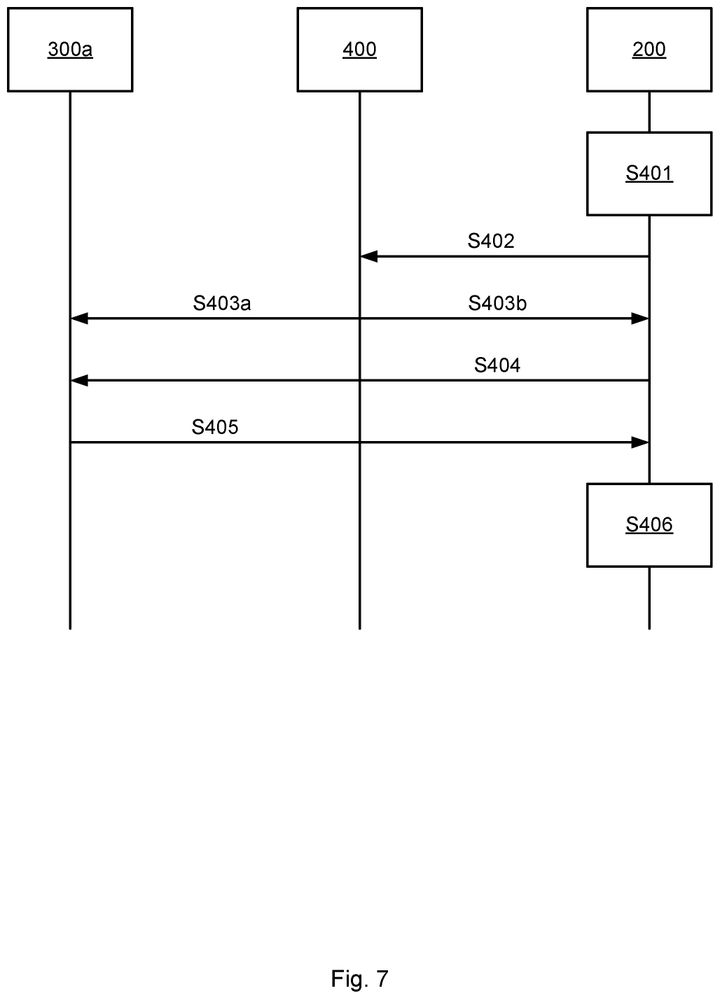

A first particular embodiment for position determination using a sidelink 160, and for enabling the same, based on at least some of the above disclosed embodiments will now be disclosed in detail with reference to the signalling diagram of FIG. 7. According to this embodiment a D2D sidelink capable first terminal device 200 enters a physical area in which at least one D2D sidelink capable second terminal device 300a is deployed. Presence of the first terminal device 200 in the area is detected by its serving network node 400. Given that D2D capabilities are provided in corresponding SIB18 messages, the first terminal device 200 can start requesting local positioning information from the second terminal device 300a. The first terminal device 200 is considered as the announcing terminal device, and the second terminal device 300a is considered as the monitoring terminal device.

S401: The first terminal device 200 enters the coverage area of the network node 400 and is informed of D2D capabilities via SIB18.

S402: The first terminal device 200 requests the network node 400 for permission to use resources for a sidelink transmission over the PC5 interface to request positioning information from potentially neighboring second terminal devices 300a.

S403a, S403b: The network node 400 indicates resource allocations for considered announcing and monitoring terminal devices. The network node 400 acknowledges use of announcement over the sidelink targeting monitoring second terminal devices 300a using selected resources. The network node 400 orders the first terminal device 200 to not to use certain uplink resources for transmissions since incoming transmissions over the sidelink is to be expected from a near announcing second terminal device 300a.

S404: The first terminal device 200 requests the second terminal device 300a to provide positioning information.

S400: The second terminal device 300a provides its positioning information to the first terminal device 200.

S406: The positioning information is received by the first terminal device 200 and, optionally, displayed to its user.

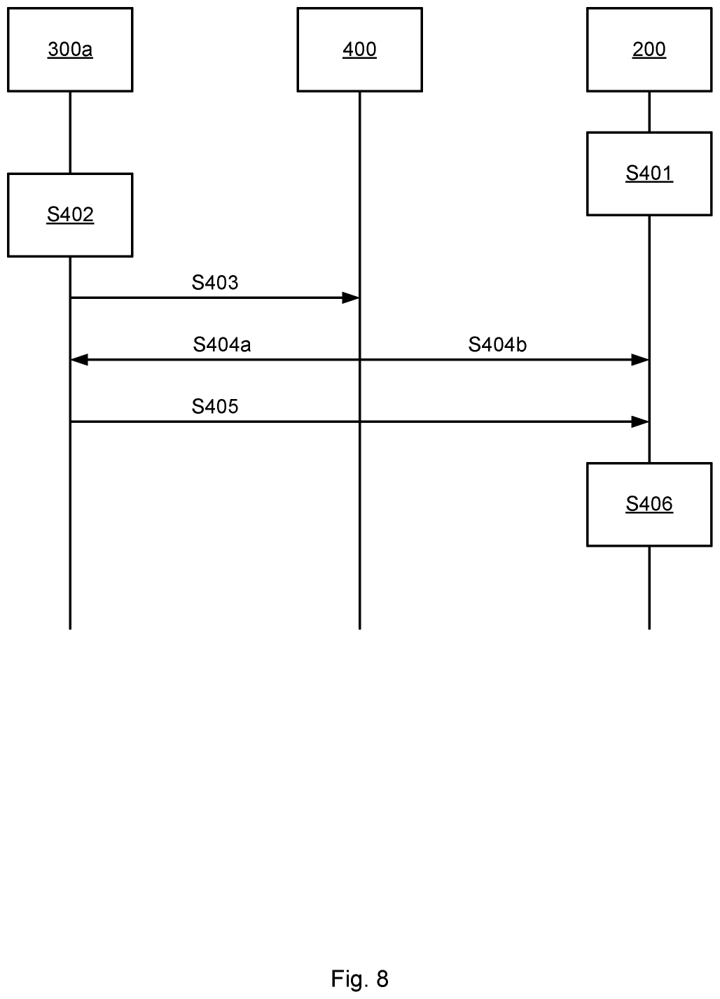

A second particular embodiment for position determination using a sidelink 160, and for enabling the same, based on at least some of the above disclosed embodiments will now be disclosed in detail with reference to the signalling diagram of FIG. 8. According to this embodiment at least one D2D capable second terminal device 300a detects the presence of an approaching first terminal device 200 using proximity detection, and initiates sidelink transmissions to provide the first terminal device 200 with positioning information. The second terminal device 300a is considered as the announcing terminal device, and the first terminal device 200 is considered as the monitoring terminal device.

S501: The first terminal device 200 enters a physical area covered by the network node 400, where the second terminal device 300a is also located in the same physical area and thus also covered by the network node 400.

S502: The second terminal device 300a detects (relatively nearby) presence of the first terminal device 200 using any suitable proximity detection, e.g. ground vibrations or lights.

S402: The first terminal device 200 requests the network node 400 for permission to use resources for a sidelink transmission over the PC5 interface to contact/convey positioning information to the first terminal device 200.

S504a, S504b: The network node 400 indicates resource allocations for considered announcing and monitoring terminal devices. The network node 400 acknowledges transmission of announcement over the sidelink targeting the first terminal device 200 using selected resources. The network node 400 orders the first terminal device 200 to not to use certain uplink resources for transmissions since incoming transmission over the sidelink is to be expected from a near announcing second terminal device 300a.

S505: The positioning information of the second terminal device 300a is provided from the second terminal device 300a to the first terminal device 200.

S506: The positioning information is received by the first terminal device 200 and, optionally, displayed to its user.

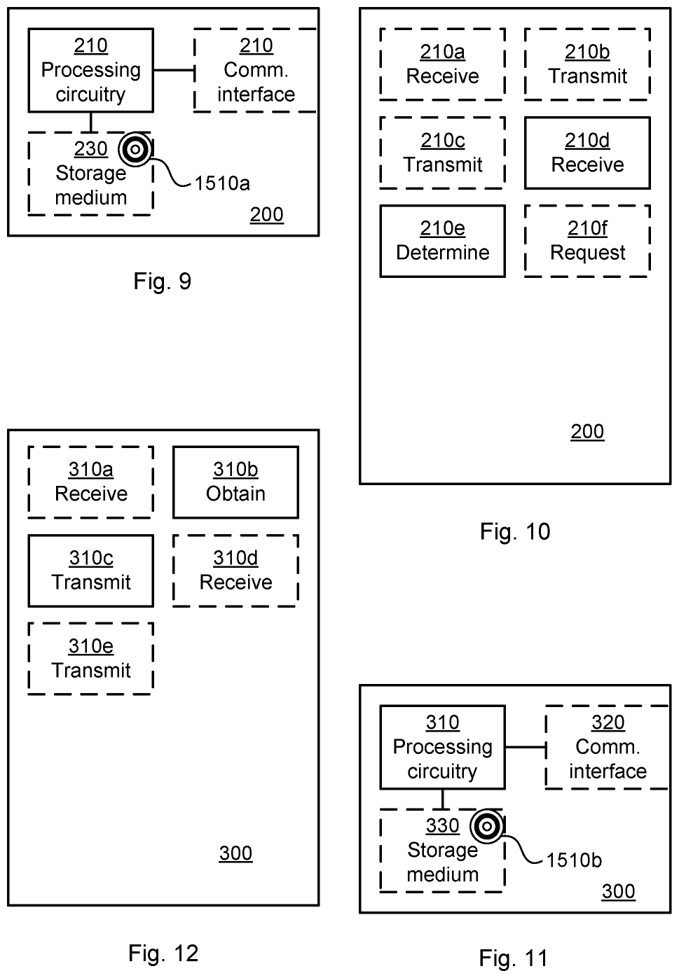

FIG. 9 schematically illustrates, in terms of a number of functional units, the components of a first terminal device 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1510a (as in FIG. 15), e.g. in the form of a storage medium 230. The processing circuitry 210 may further be provided as at least one application specific integrated circuit (ASIC), or field programmable gate array (FPGA).

Particularly, the processing circuitry 210 is configured to cause the first terminal device 200 to perform a set of operations, or steps, as disclosed above. For example, the storage medium 230 may store the set of operations, and the processing circuitry 210 may be configured to retrieve the set of operations from the storage medium 230 to cause the first terminal device 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The first terminal device 200 may further comprise a communications interface 220 for communications with other entities, functions, nodes, and devices of the communications network 100a, 100b, 100c, 100c′ such as the network node 400 and other terminal devices 300a, 300b, 300c, and the ProSe server 170. As such the communications interface 220 may comprise one or more transmitters and receivers, comprising analogue and digital components.

The processing circuitry 210 controls the general operation of the first terminal device 200 e.g. by sending data and control signals to the communications interface 220 and the storage medium 230, by receiving data and reports from the communications interface 220, and by retrieving data and instructions from the storage medium 230. Other components, as well as the related functionality, of the first terminal device 200 are omitted in order not to obscure the concepts presented herein.

FIG. 10 schematically illustrates, in terms of a number of functional modules, the components of a first terminal device 200 according to an embodiment. The first terminal device 200 of FIG. 10 comprises a number of functional modules; a receive module 210d configured to perform step S108, and a determine module 210e configured to perform step S110. The first terminal device 200 of FIG. 10 may further comprise a number of optional functional modules, such as any of a receive module 210a configured to perform step S102, a transmit module 210b configured to perform step S104, a transmit module 210c configured to perform step S106, and a request module 210f configured to perform step S112. In general terms, each functional module 210a-210f may be implemented in hardware or in software. Preferably, one or more or all functional modules 210a-210f may be implemented by the processing circuitry 210, possibly in cooperation with the communications interface 220 and the storage medium 230. The processing circuitry 210 may thus be arranged to from the storage medium 230 fetch instructions as provided by a functional module 210a-210f and to execute these instructions, thereby performing any steps of the first terminal device 200 as disclosed herein.

FIG. 11 schematically illustrates, in terms of a number of functional units, the components of a second terminal device 300a according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1510b (as in FIG. 15), e.g. in the form of a storage medium 330. The processing circuitry 310 may further be provided as at least one application specific integrated circuit (ASIC), or field programmable gate array (FPGA).

Particularly, the processing circuitry 310 is configured to cause the second terminal device 300a to perform a set of operations, or steps, as disclosed above. For example, the storage medium 330 may store the set of operations, and the processing circuitry 310 may be configured to retrieve the set of operations from the storage medium 330 to cause the second terminal device 300a to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The second terminal device 300a may further comprise a communications interface 320 for communications with other entities, functions, nodes, and devices of the communications network 100a, 100b, 100c, 100c′ such as the network node 400 and other terminal devices 200, 300b, 300c, and the ProSe server 170. As such the communications interface 320 may comprise one or more transmitters and receivers, comprising analogue and digital components.

The processing circuitry 310 controls the general operation of the second terminal device 300a e.g. by sending data and control signals to the communications interface 320 and the storage medium 330, by receiving data and reports from the communications interface 320, and by retrieving data and instructions from the storage medium 330. Other components, as well as the related functionality, of the second terminal device 300a are omitted in order not to obscure the concepts presented herein.

FIG. 12 schematically illustrates, in terms of a number of functional modules, the components of a second terminal device 300a according to an embodiment. The second terminal device 300a of FIG. 12 comprises a number of functional modules; an obtain module 310b configured to perform step S204, and a transmit module 310c configured to perform step S206. The second terminal device 300a of FIG. 12 may further comprise a number of optional functional modules, such as any of a receive module 310a configured to perform step S202, a receive module 310d configured to perform step S208, and a transmit module 310e configured to perform step S210. In general terms, each functional module 310a-310e may be implemented in hardware or in software. Preferably, one or more or all functional modules 310a-310e may be implemented by the processing circuitry 310, possibly in cooperation with the communications interface 320 and the storage medium 330. The processing circuitry 310 may thus be arranged to from the storage medium 330 fetch instructions as provided by a functional module 310a-310e and to execute these instructions, thereby performing any steps of the second terminal device 300a as disclosed herein.

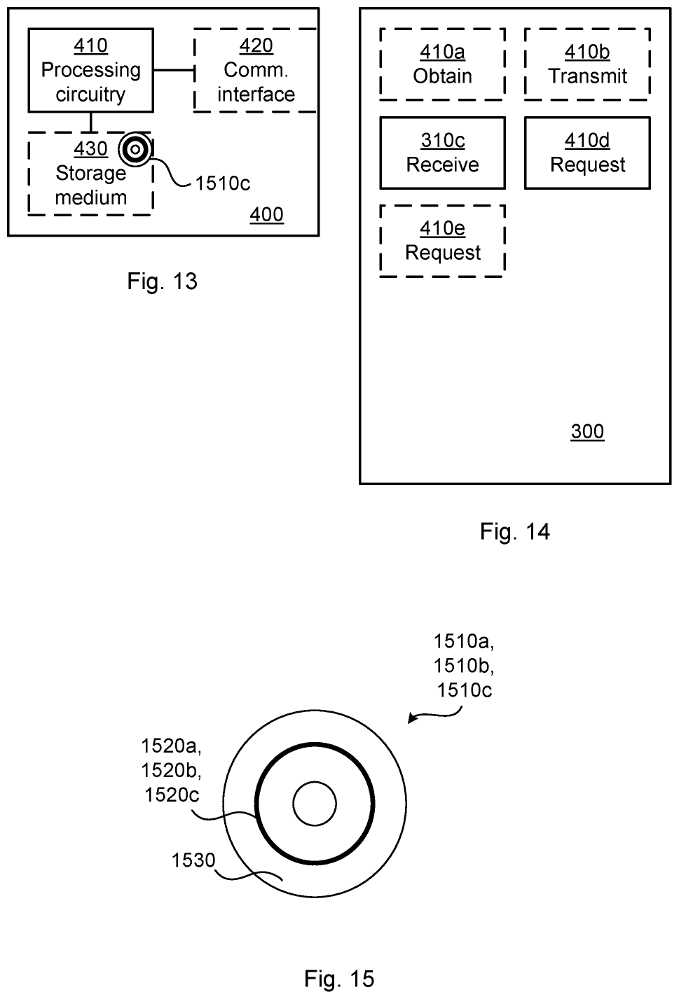

FIG. 13 schematically illustrates, in terms of a number of functional units, the components of a network node 400 according to an embodiment. Processing circuitry 410 is provided using any combination of one or more of a suitable central processing unit (CPU), multiprocessor, microcontroller, digital signal processor (DSP), etc., capable of executing software instructions stored in a computer program product 1510c (as in FIG. 15), e.g. in the form of a storage medium 430. The processing circuitry 410 may further be provided as at least one application specific integrated circuit (ASIC), or field programmable gate array (FPGA).

Particularly, the processing circuitry 410 is configured to cause the network node 400 to perform a set of operations, or steps, as disclosed above. For example, the storage medium 430 may store the set of operations, and the processing circuitry 410 may be configured to retrieve the set of operations from the storage medium 430 to cause the network node 400 to perform the set of operations. The set of operations may be provided as a set of executable instructions. Thus the processing circuitry 410 is thereby arranged to execute methods as herein disclosed.

The storage medium 330 may also comprise persistent storage, which, for example, can be any single one or combination of magnetic memory, optical memory, solid state memory or even remotely mounted memory.

The network node 400 may further comprise a communications interface 420 for communications with other entities, functions, nodes, and devices of the communications network 100a, 100b, 100c, 100c′ such as the terminal devices 200, 300a, 300b, 300c, and the ProSe server 170. As such the communications interface 420 may comprise one or more transmitters and receivers, comprising analogue and digital components.

The processing circuitry 410 controls the general operation of the network node 400 e.g. by sending data and control signals to the communications interface 420 and the storage medium 430, by receiving data and reports from the communications interface 420, and by retrieving data and instructions from the storage medium 430. Other components, as well as the related functionality, of the network node 400 are omitted in order not to obscure the concepts presented herein.

FIG. 14 schematically illustrates, in terms of a number of functional modules, the components of a network node 400 according to an embodiment. The network node 400 of FIG. 14 comprises a number of functional modules; a receive module 310c configured to perform step S306, and a request module 410 configured to perform step S308. The network node 400 of FIG. 14 may further comprise a number of optional functional modules, such as any of an obtain module 410a configured to perform step S302, a transmit module 410b configured to perform step S304, and a request module 410e configured to perform step S310. In general terms, each functional module 410a-410e may be implemented in hardware or in software. Preferably, one or more or all functional modules 410a-410e may be implemented by the processing circuitry 410, possibly in cooperation with the communications interface 420 and the storage medium 430. The processing circuitry 410 may thus be arranged to from the storage medium 430 fetch instructions as provided by a functional module 410a-410e and to execute these instructions, thereby performing any steps of the network node 400 as disclosed herein.

The network node 400 may be provided as a standalone device or as a part of at least one further device. For example, the network node 400 may be provided in a node of the radio access network or in a node of the core network. Alternatively, functionality of the network node 400 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. In this respect, at least part of the network node 400 may reside in the radio access network, such as in the radio access network node.

Thus, a first portion of the instructions performed by the network node 400 may be executed in a first device, and a second portion of the of the instructions performed by the network node 400 may be executed in a second device; the herein disclosed embodiments are not limited to any particular number of devices on which the instructions performed by the network node 400 may be executed. Hence, the methods according to the herein disclosed embodiments are suitable to be performed by a network node 400 residing in a cloud computational environment. Therefore, although a single processing circuitry 410 is illustrated in FIG. 13 the processing circuitry 410 may be distributed among a plurality of devices, or nodes. The same applies to the functional modules 410a-410e of FIG. 14 and the computer program 1520c of FIG. 15.

FIG. 15 shows one example of a computer program product 1510a, 1510b, 1510c comprising computer readable means 1530. On this computer readable means 1530, a computer program 1520a can be stored, which computer program 1520a can cause the processing circuitry 210 and thereto operatively coupled entities and devices, such as the communications interface 220 and the storage medium 230, to execute methods according to embodiments described herein. The computer program 1520a and/or computer program product 1510a may thus provide means for performing any steps of the first terminal device 200 as herein disclosed. On this computer readable means 1530, a computer program 1520b can be stored, which computer program 1520b can cause the processing circuitry 310 and thereto operatively coupled entities and devices, such as the communications interface 320 and the storage medium 330, to execute methods according to embodiments described herein. The computer program 1520b and/or computer program product 1510b may thus provide means for performing any steps of the second terminal device 300a as herein disclosed. On this computer readable means 1530, a computer program 1520c can be stored, which computer program 1520c can cause the processing circuitry 410 and thereto operatively coupled entities and devices, such as the communications interface 420 and the storage medium 430, to execute methods according to embodiments described herein. The computer program 1520c and/or computer program product 1510c may thus provide means for performing any steps of the network node 400 as herein disclosed.

In the example of FIG. 15, the computer program product 1510a, 1510b, 1510c is illustrated as an optical disc, such as a CD (compact disc) or a DVD (digital versatile disc) or a Blu-Ray disc. The computer program product 1510a, 1510b, 1510c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1520a, 1520b, 1520c is here schematically shown as a track on the depicted optical disk, the computer program 1520a, 1520b, 1520c can be stored in any way which is suitable for the computer program product 1510a, 1510b, 1510c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for position determination using a sidelink, the method being performed by a first terminal device, the method comprising:
receiving, via the sidelink from a second terminal device, positioning information of the second terminal device; and
determining its own position from the positioning information.

2. The method according to claim 1, further comprising:
transmitting, via the sidelink, a request to the second terminal device for the positioning information.

3. The method according to claim 2, wherein the first terminal device is without access to its own positioning information when transmitting the request.

4. The method according to claim 1, further comprising:
receiving information from a network node serving the first terminal device that the sidelink is establishable to the second terminal device.

5. The method according to claim 4, further comprising:
transmitting a request to the network node for establishment of the sidelink.

6. The method according to claim 1, wherein the own position is determined to be equal to a position of the second terminal device as given by the positioning information of the second terminal device.

7. The method according to claim 1, wherein the positioning information is received in a message for which a received power level is measured, and wherein the own position is determined as a function of the positioning information and the measured received power level.

8. The method according to claim 7, wherein the message comprises details of with which transmit power level the message was transmitted from the second terminal device, and wherein the own position is determined also as a function of the transmit power level.

9. The method according to claim 1, wherein pieces of positioning information of at least two second terminal devices are received, and wherein the own position is determined from a combination of all the received pieces of positioning information.

10. The method according to claim 1, wherein pieces of positioning information of at least two second terminal devices are received, and wherein the own position is determined only from the positioning information received with highest received power.

11. The method according to claim 1, wherein pieces of positioning information of at least two second terminal devices are-received, the method further comprising:
requesting at least one of the second terminal devices to reduce their transmit power when re-transmitting the positioning information.

12. The method according to claim 1, wherein the positioning information is accompanied by sensor measurements as valid for the position given by the positioning information.

13. A method for enabling position determination using a sidelink, the method being performed by a second terminal device, the method comprising:
obtaining an indication to provide its own positioning information to a first terminal device; and
transmitting, via the sidelink to the first terminal device, the positioning information.

14. The method according to claim 13, wherein the second terminal device comprises at least one sensor, and wherein the indication is obtained from input to at least one of the at least one sensor.

15. (canceled)

16. (canceled)

17. The method according to claim 13, further comprising:
receiving a request to transmit the positioning information with a reduced transmission power; and
re-transmitting, via the sidelink to the first terminal device and using the reduced transmission power, the positioning information.

18. The method according to claim 13, wherein the positioning information is transmitted in a message, and wherein the message comprises details of with which transmit power level the message was transmitted from the second terminal device.

19. The method according to claim 13, wherein the positioning information is accompanied by sensor measurements as valid for the position given by the positioning information.

20. The method according to claim 13, wherein the second terminal device is configured to have a fixed location.

21. A method for enabling position determination using a sidelink, the method being performed by a network node, the method comprising:
receiving a request from one of a first terminal device served by the network node and a second terminal device served by the network node for establishment of the sidelink between the first terminal device and the second terminal device for provision of positioning information from the second terminal device to the first terminal device; and
requesting the other of the first terminal device and the second terminal device to establish the sidelink for the provision of the positioning information from the second terminal device to the first terminal device.

22. The method according to claim 21, further comprising:
obtaining an indication that the first terminal device has entered a coverage area of the sidelink to the second terminal device; and
transmitting information to the first terminal device that the sidelink is establishable to the second terminal device.

23.-32. (canceled)
